(19) United States
(12) Patent Application Publication
(10) Pub. No.: US 2004/0123179 A1
(43) Pub. Date: Jun. 24, 2004

(54) Method, system and computer product for reliability estimation of repairable systems

(76) Inventors: Dan Dragomir-Daescu, Fargo, ND (US); Catherine Graichen, Malta, NY (US); Manoj Kumar Prabhakaran, Bangalore (IN); Cecil Daniel, Erie, PA (US)

Correspondence Address: GENERAL ELECTRIC COMPANY, GLOBAL RESEARCH, PATENT DOCKET RM. BLDG. K1-4A59, SCHENECTADY, NY, 12301-0008, US

(21) Appl. No.: 10/326,007

(22) Filed: Dec. 19, 2002

(51) Int. Cl. H02H 3/05

(52) U.S. Cl. 714/1

(57) ABSTRACT

A method for reliability estimation of repairable systems comprising receiving a plurality of discrete time intervals including a current time interval and at least one previous time interval, and associated reliability data. A failure rate of original parts in the repairable system at the end of the current time interval is computed in response to original part reliability during the current time interval and the number of original parts in the repairable system at the beginning of the current time interval. A failure rate of replacement parts in the repairable system at the end of the current time interval is computed in response to replacement part reliability during each of the previous time intervals and the number of replacement parts in the repairable system at the beginning of each of the previous time intervals. A total number of new failures for the repairable system at the end of the current time interval is estimated in response to the failure rate of original parts and the failure rate of replacement parts.

### BACKGROUND OF THE INVENTION

The present invention relates to reliability estimation of repairable systems, and more particularly, to a method for calculating system reliability that allows for the reliability of replacement parts to be different than that of the original parts and accounts for time dependent failure rates for each known failure mode.

A repairable system can be characterized as a system that is repaired rather than replaced after a failure. The dependability of a repairable system is determined by the properties of its components and by the repair strategy. Reliability evaluation can be performed early during system design in order to design a repairable system with maximized system reliability and/or minimal warranty costs. Reliability evaluation can also be utilized to determine warranty costs and to determine pricing for maintenance agreements. Analysis of a particular system in order to determine the likelihood of failure of system parts can be used as input to the pricing process. Reliability evaluation is also utilized to predict the number of spare parts that will have to be manufactured and/or purchased and kept on-site with a system in order to assure speedy recovery from failures. In addition, the number of on-site and remote service personnel that will be required to support a particular system or fleet of systems can be estimated with input from reliability evaluation. Accurate reliability evaluation can assist in increased customer satisfaction due to fewer outages and it can lead to decreased costs due to streamlined repair strategies and better pricing of warranties and maintenance agreements.

Current renewal theories and algorithms make the assumption that after a repair is performed, the system is restored to the initial, or “as new” condition. Typically, this is the case only if the system has received a complete overhaul or if all of the parts have been replaced. Otherwise, even after a system has been repaired there are parts that were not repaired remaining in the system that have not been restored to their initial condition. Also, other simplifications in current theories and algorithms, such as the assumption that the times between failures and the times between repairs each have independent and identical distributions, can lead to inaccurate reliability estimates. In addition, current methods do not take into account system degradation through time dependent failure rates for different failure modes.

### BRIEF DESCRIPTION OF THE INVENTION

One aspect of the invention is a method for reliability estimation of repairable systems. The method comprises receiving a plurality of discrete time intervals including a current time interval and at least one previous time interval, and associated reliability data. A failure rate of original parts in the repairable system at the end of the current time interval is computed in response to original part reliability during the current time interval and the number of original parts in the repairable system at the beginning of the current time interval. A failure rate of replacement parts in the repairable system at the end of the current time interval is computed in response to replacement part reliability during each of the previous time intervals and the number of replacement parts in the repairable system at the beginning of each of the previous time intervals. A total number of new failures for the repairable system at the end of the current time interval is estimated in response to the failure rate of original parts and the failure rate of replacement parts.

Another aspect of the invention is a method for reliability estimation of repairable systems. The method comprises estimating a total number of new failures for a repairable system at the end of a current time interval, k, where k is a positive integer and the replacement parts include a type1 replacement part and a type2 replacement part. The total number of new failures for the current time interval is calculated using the formula:

$${n}_{{f}_{k}} = {P}_{k} {N}_{k - 1} + {\sum }_{j = 1}^{k - 1} ( {P}_{k - j}^{type 1} {n}_{j , k - 1}^{type 1} + {P}_{k - j}^{type 2} {n}_{j , k - 1}^{type 2} )$$

where Pₖ is the probability that an original part fails in the kth time interval, Nₖ₋₁ is the number of original parts that have remained in the system at the end of the (k−1)th time interval, j is a loop counter represented as a positive integer less than k, Pₖ₋ⱼ^{type1} is the probability that a type1 replacement part that was installed at the end of the jth time interval will fail in the kth time interval, n_{j,k-1}^{type1} is the number of type1 replacement parts that were installed at the end of the jth time interval and survived the (k−1)th time interval, Pₖ₋ⱼ^{type2} is the probability that a type2 replacement part that was installed at the end of the jth time interval will fail in the kth time interval and n_{j,k-1}^{type2} is the number of type2 replacement parts that were installed at the end of the jth time interval and survived the (k−1)th time interval.

A further aspect of the invention is a computer program product for reliability estimation of repairable systems. The computer product comprises a storage medium readable by a processing circuit and storing instructions for execution by the processing circuit for performing a method that comprises receiving a plurality of discrete time intervals including a current time interval and at least one previous time interval, and associated reliability data. A failure rate of original parts in the repairable system at the end of the current time interval is computed in response to original part reliability during the current time interval and the number of original parts in the repairable system at the beginning of the current time interval. A failure rate of replacement parts in the repairable system at the end of the current time interval is computed in response to replacement part reliability during each of the previous time intervals and the number of replacement parts in the repairable system at the beginning of each of the previous time intervals. A total number of new failures for the repairable system at the end of the current time interval is estimated in response to the failure rate of original parts and the failure rate of replacement parts.

A further aspect of the invention is a reliability estimation system for reliability estimation of repairable systems. The reliability estimation system comprises a computer programmed to implement a method comprising receiving a plurality of discrete time intervals including a current time interval and at least one previous time interval, and associated reliability data. A failure rate of original parts in the repairable system at the end of the current time interval is computed in response to original part reliability during the current time interval and the number of original parts in the repairable system at the beginning of the current time interval. A failure rate of replacement parts in the repairable system at the end of the current time interval is computed in response to replacement part reliability during each of the previous time intervals and the number of replacement parts in the repairable system at the beginning of each of the previous time intervals. A total number of new failures for the repairable system at the end of the current time interval is estimated in response to the failure rate of original parts and the failure rate of replacement parts.

Further aspects of the invention are disclosed herein. The above discussed and other features and advantages of the present invention will be appreciated and understood by those skilled in the art from the following detailed description and drawings.

### BRIEF DESCRIPTION OF THE DRAWINGS

Referring to the exemplary drawings wherein like elements are numbered alike in the several Figures:

FIG. 1 is an exemplary process for implementing a repair strategy for a repairable system;

FIG. 2 is an exemplary process for calculating the reliability of a repairable system; and

FIG. 3 is an example calculation of the reliability of a repairable system utilizing an embodiment of the present invention.

### DETAILED DESCRIPTION OF THE INVENTION

An embodiment of the present invention is a probabilistic method for reliability estimation of a repairable system when repairs are made with parts that have varying reliability characteristics. Time to failure data is processed to produce the estimation of various part reliabilities under a renewal process policy. The replacement parts are allowed to have either the same reliability or a different reliability than the original parts. A discrete time procedure based on statistical failure data is employed to compute the reliability of the original parts when repairs with parts that have known reliability characteristics are performed at the end of each time interval to replace the failed parts. An embodiment of the present invention addresses the change in the reliability of a repairable system when parts with reliability different than that of the original part reliability are used as replacements. For example, if parts from a different supplier are used as replacements, or a change in the repair policy requires the use of parts with a different design, or older parts are used for repair purposes, an embodiment of the present invention allows for a reliability calculation that includes information about the modified reliability of the replacements. The method and algorithm of the present invention incorporate such information while providing robust estimates of the new system reliability, for example, through the calculation of the expected number of failures in a certain time interval under a modified repair policy that includes replacement parts of varied reliability.

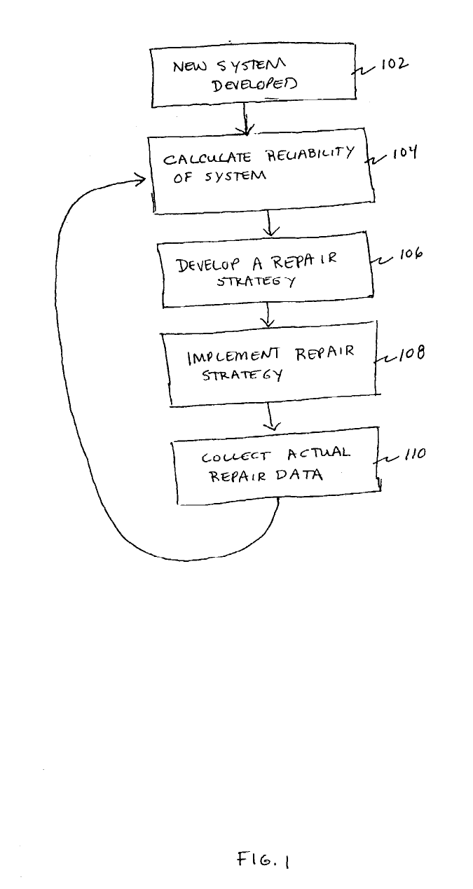

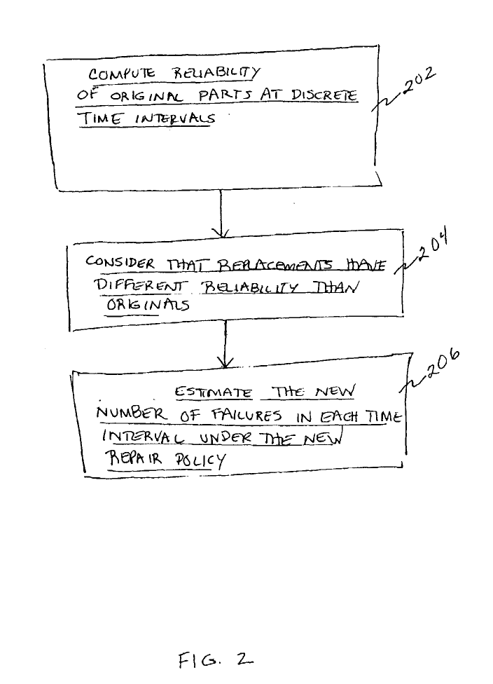

FIG. 1 is an exemplary process for implementing a repair strategy for a repairable system. At step 102, a new repairable system is developed. Examples of repairable systems include locomotive engine parts and jet engine parts. At step 104 the reliability of the system is calculated using a method such as the one described below in reference to FIG. 2. Various reliability estimates can be created by varying the reliability of replacement parts and the time intervals for performing repairs. A repair strategy is developed at step 106 based, in part, on the reliability estimates developed in step 104. The repair strategy can include items such as the length of time between repairs and the percentage of various replacement parts to be utilized at the different time intervals. At step 108, the repair strategy is implemented on the system. Implementation can include checking the system at the end of each time interval and replacing failing parts with replacement parts of varying reliability based on the repair strategy. At step 110, the actual repair data is collected for the system. The repair data is then utilized to improve the reliability estimation at step 104. The loop between step 104 and step 110 continues for the life of the system resulting in more accurate reliability calculations with time. In this manner, an improved reliability estimate is created for the system based on actual failure data. An embodiment of the present invention can be utilized to provide input to the design process for a repairable system in the design phase. Various system reliability calculations can be performed and repair strategies developed in order to assess the cost of maintaining various design alternatives. The reliability calculations and repair strategies can be utilized during the design process to assist in designing a system with a lower cost to maintain and/or higher reliability.

FIG. 2 is an exemplary process for calculating the reliability of a repairable system. At step 202, the reliability of original parts at discrete time intervals is computed. The reliability calculations can be based on non-parametric statistical analysis of time to failure data or time between failure data. Non-parametric statistical analysis tools such as product-limit estimator (e.g., Kaplan-Meyer) or cumulative-hazard estimator (e.g., Nelson) can be utilized to perform the reliability calculations. Alternatively, a parametric analysis (e.g., Weibull and lognormal) can be utilized. The reliability under various failure modes and mechanisms can also be considered. The reliability computation is done in discrete time, the time interval being chosen according to the actual repair policy. If the replacements are similar in reliability to the originals, the proposed method accounts for the actual in-service time of the replacement parts for the reliability calculations. The probability of failure of the original parts is computed in each time interval. The failure rate or probability of failure is derived from computing the number of failures. Therefore, computing the number of failures is equivalent to computing a failure rate.

At step 204, the calculation of system reliability takes into account a new repair policy where replacement parts have different reliability than the original parts. The probability of failure of the original parts and the probability of failure of the replacement parts in each time interval is utilized to compute the new reliability under the modified repair policy. The same reliability estimators used in step 202 are utilized for the original parts. The replacement parts can have different reliabilities among them. At step 206, the new number of failures under the new repair policy is estimated. This can be compared to the number of failures under the original policy where replacement parts had the same reliability as the original parts. The number of new failure differential (positive or negative) is a measure of risk increase or decrease under the new policy. This can be utilized to estimate the increase or decrease in the repair or maintenance costs.

In an exemplary embodiment, the mathematical algorithm that follows can be utilized to implement the processing described above in reference to FIG. 2. The mathematical algorithm estimates the new number of failures in the kth time interval. In the following algorithm it is assumed that there are two types of replacement parts, the refurbished unit exchange (UX) replacement parts with the same reliability as the original parts and the used, removed from running equipment (RTO) replacement parts that have a different reliability than the original parts. An alternate embodiment of the present invention could be utilized to support any number of different types of replacement parts with any number of reliability ratings and it is not necessary that any of the replacement parts have the same reliability as the original parts. The estimate of the total number of replacements that will be made at the end of the kth time interval, n_{k,k}, or failures that will have occurred during the kth time interval, n_{ƒk} can be expressed as:

n_{ƒk}=PₖNₖ₋₁+(pₖ₋₁^{UX}n_{1,k-1}^{UX}+pₖ₋₁^{RTO}n_{1,k-1}^{RTO})+(pₖ₋₂^{UX}n_{2,k-1}^{UX}+pₖ₋₂^{RTO}n_{2,k-1}^{RTO})++(pₖ₋₁^{UX}n_{3,k-1}^{UX}+pₖ₋₃^{RTO}n_{3,k-1}^{RTO})+ . . . +(p₂^{UX}n_{k-2,k-1}^{UX}+p₂^{RTO}n_{k-2,k-1}^{RTO})+(p₁^{UX}n_{k-1,k-1}^{UX}+p₁^{RTO}n_{k-1,k-1}^{RTO})

or alternatively as:

$${n}_{{f}_{k}} = {P}_{k} {N}_{k - 1} + {\sum }_{j = 1}^{k - 1} ( {P}_{k - j}^{UX} {n}_{j , k - 1}^{UX } + {P}_{k - j}^{RTO} {n}_{j , k - 1}^{RTO} )$$

where:

pₖ is the probability that an original part fails in the kth time interval, Nₖ₋₁ is the number of original parts that remained at the end of the previous time interval; and PₖNₖ₋₁=ΔNₖ, represents the number of parts from the original population of parts that will fail in the kth time interval;

pₖ₋₁^{UX} is the probability that a UX part that was installed as a replacement at the end of the first time interval will fail in the kth time interval, n_{1,k-1}^{UX} is the number of UX replacement parts that were installed at the end of the first time interval that survived the (k−1)th time interval; and pₖ₋₁^{UX} n_{1,k-1}^{UX}=Δn_{1,k}^{UX}, represents the number of parts from the UX replacements made at the end of the first time interval that will fail in the kth time interval;

pₖ₋₁^{RTO} is the probability that a RTO part that was installed as a replacement at the end of the first time interval will fail in the kth time interval, n_{1,k-1}^{RTO} is the number of RTO replacement parts that were installed at the end of the first time interval that survived the (k−1)th time interval; and pₖ₋₁^{RTO}n_{1,k-1}^{RTO}=Δn_{1,k}^{RTO}, represents the number of parts from the RTO replacements made at the end of the first time interval that will fail in the kth time interval;

pₖ₋₂^{UX} is the probability that a UX part that was installed as a replacement at the end of the second time interval will fail in the kth time interval, n_{2,k-1}^{UX} is the number of UX replacement parts that were installed at the end of the second time interval that survived the (k−1)th time interval; and pₖ₋₂^{UX}n_{2,k-1}^{UX}=Δn_{2,k}^{UX}, represents the number of parts from the UX replacements made at the end of the second time interval that will fail in the kth time interval;

pₖ₋₂^{RTO} is the probability that a RTO part that was installed as a replacement at the end of the second time interval will fail in the kth time interval, n_{2,k-1}^{RTO} is the number of RTO replacement parts that were installed at the end of the second time interval that survived the (k−1)th time interval; and pₖ₋₂^{RTO}n_{2,k-1}^{RTO}=Δn_{2,k}^{RTO}, represents the number of parts from the RTO replacements made at the end of the second time interval that will fail in the kth time interval;

pₖ₋ⱼ^{UX} is the probability that a UX part that was installed as a replacement at the end of the jth time interval will fail in the kth time interval, n_{j,k-1}^{UX} is the number of UX replacement parts that were installed at the end of the jth time interval that survived the (k−1)th time interval; and pₖ₋ⱼ^{UX}n_{j,k-1}^{UX}=Δn_{j,k}^{UX}, represents the number of parts from the UX replacements made at the end of the jth time interval that will fail in the kth time interval;

pₖ₋ⱼ^{RTO} is the probability that a RTO part that was installed as a replacement at the end of the jth time interval will fail in the kth time interval, n_{j,k-1}^{RTO} is the number of RTO replacement parts that were installed at the end of the jth time interval that survived the (k−1)th time interval; and pₖ₋ⱼ^{RTO}n_{j,k-1}^{RTO}=Δn_{j,k}^{RTO}, represents the number of parts from the RTO replacements made at the end of the jth time interval that will fail in the kth time interval;

p₁^{UX} is the probability that a UX part that was installed as a replacement at the end of the (k−1)th time interval will fail in the kth time interval, n_{k-1,k-1}^{UX} is the number of UX replacement parts that were installed at the end of the (k−1)th time interval; and p₁^{UX}n_{k-1,k-1}^{UX}=Δn_{k-1,k}^{UX}, represents the number of parts from the UX replacements made at the end of the (k−1)th time interval that will fail in the kth time interval; and

p₁^{RTO} is the probability that a RTO part that was installed as a replacement at the end of the (k−1)th time interval will fail in the kth time interval, n_{k-1,k-1}^{RTO} is the number of RTO replacement parts that were installed at the end of the (k−1)th time interval; and p₁^{RTO}n_{k-1,k-1}^{RTO}=Δn_{k-1,k}^{RTO}, represents the number of parts from the RTO replacements made at the end of the (k−1)th time interval that will fail in the kth time interval.

In addition, for use in calculating the reliability of the (k+1)th interval:

Nₖ=Nₖ₋₁−ΔNₖ, represents the number of parts from the original population surviving the kth time interval;

n_{1,k}^{UX}=n_{1,k-1}^{UX}−Δn_{1,k}^{UX}, represents the number of UX replacement parts installed at the end of the first time interval that survived the kth time interval;

n_{1,k}^{RTO}=n_{1,k-1}^{RTO}−Δn_{1,k}^{RTO}, represents the number of RTO replacement parts installed at the end of the first time interval that survived the kth time interval;

n_{j,k}^{UX}=n_{j,k-1}^{UX}−Δn_{j,k}^{UX}, represents the number of UX replacement parts installed at the end of the jth time interval that survived the kth time interval;

n_{j,k}^{RTO}=n_{j,k-1}^{RTO}−Δn_{j,k}^{RTO}, represents the number of RTO replacement parts installed at the end of the jth time interval that survived the kth time interval;

n_{k-1,k}^{UX}=n_{k-1,k-1}^{UX}−Δn_{k-1,k}^{UX}, represents the number of UX replacement parts installed at the end of the (k−1)th time interval that survived the kth time interval; and

n_{k-1,k}^{RTO}=n_{k-1,k-1}^{RTO}−Δ_{k-1,k}^{RTO}, represents the number of RTO replacement parts installed at the end of the (k−1)th time interval that survived the kth time interval.

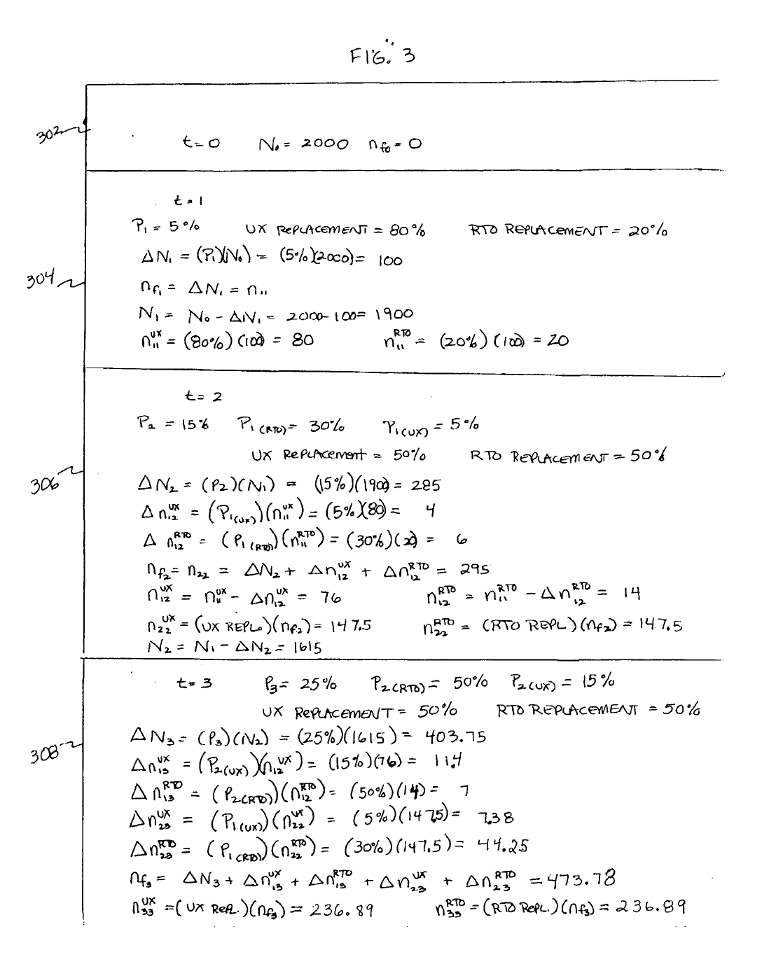

FIG. 3 includes an example calculation of the reliability of a repairable system utilizing an embodiment of the present invention. Box 302 represents the starting state of the repairable system, when the system is first put into service at time zero and the number of failing parts is equal to zero. In this example, the number of original parts is equal to two thousand. Box 304 represents the end of the first time interval. The probability of original parts failing by the end of the first time interval, P₁ is five percent. In addition, eighty percent of failing parts will be replaced with a UX replacement part and twenty percent of failing parts will be replaced with a RTO replacement part. The number of failures, n_{ƒ1}, at the end of the first time interval is one-hundred and the number of original parts surviving the first time interval, N₁, is nineteen-hundred. Eighty of the failing parts will be replaced with UX parts and twenty of the failing parts will be replaced with RTO parts.

Box 306 represents the end of the second time interval. The probability of original parts failing by the end of the second time interval, P₂, is fifteen percent. The increase in the probability of failure could be due to factors including system degradation over time. In addition, the probability of UX replacement parts failing after one time interval, P₁^{UX}, is five percent and the probability of RTO replacement parts failing after one time interval, P₁^{RTO}, is thirty percent. At the end of the second time interval, fifty percent of failing parts will be replaced with a UX replacement part and fifty percent of failing parts will be replaced with a RTO replacement part. The calculation for the number of failures, n_{ƒ2}, at the end of the second time interval is calculated as shown in box 306 and results in two-hundred and ninety-five parts being estimated for replacement. Two-hundred and eighty-five of the parts come from the original parts, four parts from the UX replacements at the end of the first time interval and six parts from the RTO replacements at the end of the first time interval. As shown in box 306, half the parts will be replaced with RTO replacement parts and half with UX replacement parts.

Box 308 represents calculations performed to predict the end of the third time interval. The probability of original parts failing by the end of the third time interval, P₃, is twenty-five percent. In addition, the probability of UX replacement parts failing after two time intervals, P₂^{UX}, is fifteen percent and the probability of RTO replacement parts failing after two time intervals, P₂^{RTO}, is fifty percent. At the end of the third time interval, fifty percent of failing parts will be replaced with a UX replacement part and fifty percent of failing parts will be replaced with a RTO replacement part. The calculation for the number of failures, n_{ƒ3}, at the end of the third time interval is calculated as shown in box 308 and includes considerations for the reliability of replacement parts that were installed at the end of the first and second time intervals. The number of failures occurring during the third time interval is calculated to be equal to four-hundred seventy-three and seventy-eight hundredths. Four-hundred three and three quarters of the failing parts come from the original parts, eleven and four tenths from UX replacement parts installed at the end of the first time interval, seven from RTO replacement parts installed at the end of the first time interval, seven and thirty-eight hundredths from UX replacement parts installed at the end of the second time interval, and forty-four and one quarter from RTO replacement parts installed at the end of the second time interval. As shown in box 308, half the parts will be replaced with RTO replacement parts and half with UX replacement parts. In an exemplary embodiment, the number of failures and replacement parts are rounded to the nearest unit (i.e., integer).

FIG. 3 depicts example calculations for three time intervals, two sets of replacement parts with different reliability rates and a replacement strategy that varies between time intervals. The calculations could be continued for any number of time intervals and could be expanded to include other replacement parts that are introduced at a later time interval. The number of time intervals could depend on major maintenance activities, for example, the system could be a locomotive engine and the time intervals may be reset to zero after a complete engine overhaul has been performed. In addition, the same calculations could be utilized to calculate the reliability of a system that uses only replacement parts with the same reliability as the original parts. This could be accomplished by defining one replacement part with a reliability predictor equal to that of the original parts. The reliability calculation can be performed based on known data if it is available or it may be performed based on estimated reliability data (e.g., data obtained from a physics based model) and updated based on actual data when it becomes available. An embodiment of the present invention may be utilized to estimate average, optimal and worse case reliability by modifying the inputs to the algorithm.

An embodiment of the present invention provides the ability to estimate repairable system reliability under different repair and maintenance policies. This can lead to better pricing models for maintenance and warranty costs. The ability to provide these costs based on data that is sensitive to the changes in a repairable system when parts with different reliability are used as replacements for failed parts can allow for more accurate reliability estimates. The method and algorithm of an embodiment of the present invention utilizes both statistical data (if available) to calculate the reliability of various system parts and estimated new reliability data when the repair is performed with replacement parts that differ in reliability from the original parts when actual repair data is not available. This allows for replacements from different sources (e.g., categories) in any ratio in the total replacement pool. For example, at the end of one time interval, the UX pool might provide eighty percent of repairs and the RTO pool might provide twenty percent of repairs. This would result in a four to one ratio between UX and RTO repairs. This ratio may vary from time interval to time interval as different numbers of UX and RTO replacement parts become available. The ability to choose replacements from a variety of sources can lead to decreased costs and higher customer satisfaction due to faster repairs. In addition, an embodiment of the present invention allows for the reliability to be estimated either for the mixed failure modes of a system or for individual failure modes of interest on a system. This can lead to increased flexibility and accuracy of the reliability estimate.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for reliability estimation of repairable systems, the method comprising:
receiving a plurality of discrete time intervals including a current time interval and at least one previous time interval, and associated reliability data;
computing a failure rate of original parts in a repairable system at the end of said current time interval in response to original part reliability during said current time interval and the number of original parts in the repairable system at the beginning of said current time interval;
computing a failure rate of replacement parts in the repairable system at the end of said current time interval in response to replacement part reliability during each said previous time interval and the number of replacement parts in the repairable system at the beginning of each said previous time interval; and
estimating a total number of new failures for the repairable system at the end of said current time interval in response to said failure rate of original parts and said failure rate of replacement parts.

2. The method of claim 1 wherein said replacement parts include a first part type and a second part type with different replacement part reliabilities in one or more of said discrete time intervals.

3. The method of claim 2 wherein said first part type and said second part type are installed in said repairable system in different ratios at the end of two or more of said discrete time intervals.

4. The method of claim 2 wherein said first part type corresponds to a higher replacement part reliability than said reliability of original parts and said second part type corresponds to a lower replacement part reliability than said reliability of original parts.

5. The method of claim 2 wherein said second part type corresponds to a replacement part reliability that is the same as said original part reliability.

6. The method of claim 1 wherein said replacement parts consist of said original parts.

7. The method of claim 1 wherein said discrete time intervals are one month.

8. The method of claim 1 wherein said discrete time intervals are one hour.

9. The method of claim 1 wherein said original part reliability varies between two or more of said discrete time intervals.

10. The method of claim 1 wherein said original part reliability is derived from repair data.

11. The method of claim 1 wherein said original part reliability is derived from expected repair data.

12. The method of claim 1 wherein said replacement part reliability varies between two of said discrete time intervals.

13. The method of claim 1 wherein said replacement part reliability is derived from repair data.

14. The method of claim 1 wherein said replacement part reliability is derived from expected repair data.

15. The method of claim 1 wherein said system is a locomotive engine.

16. The method of claim 1 further comprising collecting actual repair data for the repairable system, wherein said estimating further comprises using said actual repair data.

17. The method of claim 1 further comprising developing a repair strategy for said repairable system responsive to said estimating.

18. The method of claim 17 further comprising implementing said repair strategy.

19. A method for reliability estimation of repairable systems, the method comprising:
estimating a total number of new failures for a repairable system at the end of a current time interval, k, wherein k is a positive integer, replacement parts include a type1 replacement part and a type2 replacement part and said total number of new failures for said current time interval is calculated as:
$${n}_{{f}_{k}} = {P}_{k} {N}_{k - 1} + {\sum }_{j = 1}^{k - 1} ( {P}_{k - j}^{type 1} {n}_{j , k - 1}^{type 1} + {P}_{k - j}^{type 2} {n}_{j , k - 1}^{type 2} )$$
where Pₖ is the probability that an original part fails in the kth time interval, Nₖ₋₁ is the number of original parts that have remained in the repairable system at the end of the (k−1)th time interval, j is a loop counter represented as a positive integer less than k, Pₖ₋ⱼ^{type1} is the probability that a type1 replacement part that was installed at the end of the jth time interval will fail in the kth time interval, n_{j,k-1}^{type1} is the number of type1 replacement parts that were installed at the end of the jth time interval and survived the (k−1)th time interval, Pₖ₋ⱼ^{type2} is the probability that a type2 replacement part that was installed at the end of the jth time interval will fail in the kth time interval and n_{j,k-1}^{type2} is the number of type2 replacement parts that were installed at the end of the jth time interval and survived the (k−1)th time interval.

20. A computer program product for reliability estimation of repairable systems, comprising:
a storage medium readable by a processing circuit and storing instructions for execution by the processing circuit for:
receiving a plurality of discrete time intervals including a current time interval and at least one previous time interval, and associated reliability data;
computing a failure rate of original parts in a repairable system at the end of said current time interval in response to original part reliability during said current time interval and the number of original parts in the repairable system at the beginning of said current time interval;
computing a failure rate of replacement parts in the repairable system at the end of said current time interval in response to replacement part reliability during each said previous time interval and the number of replacement parts in the repairable system at the beginning of each said previous time interval; and
estimating a total number of new failures for the repairable system at the end of said current time interval in response to said failure rate of original parts and said failure rate of replacement parts.

21. The computer program product of claim 20 wherein said replacement parts include a first part type and a second part type with different replacement part reliabilities in one or more of said discrete time intervals.

22. The computer program product of claim 21 wherein said first part type and said second part type are installed in said repairable system in different ratios at the end of two or more of said discrete time intervals.

23. A reliability estimation system for reliability estimation of repairable systems, the reliability estimation system comprising:
a computer programmed to implement a method comprising:
receiving a plurality of discrete time intervals including a current time interval and at least one previous time interval and associated reliability data;
computing a failure rate of original parts in a repairable system at the end of said current time interval in response to original part reliability during said current time interval and the number of original parts in the repairable system at the beginning of said current time interval;
computing a failure rate of replacement parts in the repairable system at the end of said current time interval in response to replacement part reliability during each said previous time interval and the number of replacement parts in the repairable system at the beginning of each said previous time interval; and
estimating a total number of new failures for the repairable system at the end of said current time interval in response to said failure rate of original parts and said failure rate of replacement parts.

24. The reliability estimation system of claim 23 wherein said replacement parts include a first part type and a second part type with different replacement part reliabilities in one or more of said discrete time intervals.

25. The reliability estimation system of claim 24 wherein said first part type and said second part type are installed in said repairable system in different ratios at the end of two or more of said discrete time intervals.
